(19) United States
(12) Patent Application Publication
(10) Pub. No.: US 2012/0014019 A1
(43) Pub. Date: Jan. 19, 2012

(54) METHOD OF OPERATING A HOUSEHOLD APPLIANCE

(75) Inventors: Christian Duscher, Nittendorf (DE); Ralf Hochhausen, Lappersdorf (DE)

(73) Assignee: BSH BOSCH UND SIEMENS HAUSGERATE GMBH, Munich (DE)

(21) Appl. No.: 13/180,580

(22) Filed: Jul. 12, 2011

(30) Foreign Application Priority Data
Jul. 19, 2010 (DE) 10 2010 031 517.6

(51) Int. Cl. H02H 5/04

(52) U.S. Cl. 361/24

(57) ABSTRACT

In a method for operating a household appliance having at least one electrical consumer activated by power electronics an actual value representing a temperature loading of the power electronics is determined and compared with a limit value representing a maximum tolerable temperature loading of the power electronics in normal load operation. When the actual value is below the limit value; an overload operation is enabled at least temporarily with a higher power than in normal load operation.

### BACKGROUND OF THE INVENTION

The invention relates to a method for operating a household appliance, in particular a dishwasher, featuring at least one electrical consumer, the electrical consumer being activated by power electronics, with an actual value representing the temperature loading of the power electronics first being determined and the actual value then being compared with a limit value representing the maximum tolerable temperature loading of the power electronics during normal load operation.

Household appliances, such as water-carrying household appliances, e.g. dishwashers or washing machines, laundry dryers or washer dryers, and even ovens and refrigerators feature at least one electrical consumer activated using power electronics. In the case of water-carrying household appliances this can be an electric motor driving a pump, in the case of ovens for example electrical heating facilities and in the case of refrigerators an electric motor driving a compressor. It can also be a fan motor of a household appliance.

Dishwashers generally feature at least one pump driven by an electric motor. A permanently excited synchronous motor is frequently used as the electric motor here. The electric motor is activated with the aid of power electronics in particular featuring semiconductor elements. It is known here first to determine an actual value representing the temperature loading of the power electronics and then to compare this with a limit value. As set out for example in patent specification DE 202082 and the unexamined application DE 2004 022 005 A1, such a comparison is used to protect against thermal overload. Thus when the actual value reaches the limit value, the motor current or setpoint power of the electric motor is reduced to protect components against thermal overload.

### BRIEF SUMMARY OF THE INVENTION

It is an object of the invention to create a method that allows improved operation in a simple manner.

The inventive object is achieved by at least a temporary enabling of an overload operation, wherein a higher power than in normal load operation is present, when the actual value is below the limit value, whereby during (permanent) normal load operation of the power electronics or the electric motor the limit value represents the maximum tolerable temperature loading of the power-electronics, i.e. a maximum limit value in respect of the maximum tolerable temperature loading at which the power electronics suffer damage. Provision is thus made, when the detected actual value is below the limit value, which is determined for example by tests or was defined beforehand by means of calculation, for an overload operation to be enabled at least temporarily, with the power of the electric motor and therefore the temperature loading of the power electronics in overload operation exceeding the power and temperature loading during normal load operation. The power electronics suffer damage when a part or structural unit or functional unit of the power electronics has suffered damage due to an impermissibly high temperature loading. This part or component unit can be for example the frequency converter. A part can also refer to a component.

The electrical consumer here can be an electric motor, e.g. a permanently excited synchronous motor, for driving a pump, e.g. for conveying a fluid or for driving a compressor of a refrigerator. The electrical consumer can also be electrical aids or a fan drive.

A maximum enable time for the overload operation is preferably defined as a function of the difference between the actual value and the limit value, so that the overload operation is terminated before or when the actual value reaches or exceeds the limit value. Use is made here of the fact that the temperature of the power electronics cannot change suddenly so that a short-term overload operation is possible without the power electronics overheating. This allows increased power to be made available at a given time.

The actual value is moreover preferably determined as a function of an actual consumer current, in particular at least one actual phase current, e.g. of an electric motor. The actual consumer or motor current can be determined and processed in a simple manner by means of a suitable circuit or suitable sensors.

The actual value is advantageously determined by forming a limit load integral. The limit load integral is a criterion for the short-term overload of a semiconductor component. The limit load integral can be used to determine the actual value that can be present within a specified time period without it exceeding the limit value or without the semiconductor component overheating.

To this end the actual value is preferably determined by integrating the squared actual consumer or motor current, in particular the actual phase current, e.g. of an electric motor. The integration time here is expediently set as a function of a known thermal time constant of the power electronics, in particular as a function of a known thermal time constant of at least one semiconductor element of the power electronics, to take into account the heating behaviour of the power electronics. This means that the mean power loss, converted to heat in the end stage of the power electronics, is limited.

It is particularly preferable for the overload operation to be enabled until the actual value reaches the limit value. It is possible here to regulate the duration of the overload operation by directly comparing the actual value and limit value, to prevent an overloading of the power electronics.

When the actual value reaches the limit value the actual consumer or motor current, in particular the actual phase current, is preferably limited. As a result the heating of the power electronics, in particular due to conduction losses of a semiconductor element, is restricted by the limiting of the actual consumer or motor current or output current. The power loss can thus be limited by reducing the phase current, for example by reducing the rotation speed of the electric motor.

It is particularly preferable for the limit value to be predetermined as a function of an intermediate circuit voltage of the power electronics. This takes into account the known switching losses as a function of intermediate circuit voltage during overload protection. Finally provision is made for the actual consumer or motor current in overload operation to be limited as a function of component-specific parameters. This prevents component parts of the power electronics and/or the electrical consumer being damaged due to too high an actual motor current in overload operation. The component-specific parameters can also be determined by tests or by calculation and be stored in the activation electronics.

The inventive household appliance is characterised in that the facility enables an overload operation, in which a higher power is present than in normal load operation, when the actual value is below the limit value. The facility preferably comprises a sensor and/or a circuit for detecting the actual consumer current as the actual value to be compared.

The power electronics preferably comprises several semiconductor elements, which serve to activate the electric motor. The semiconductor elements are preferably configured as what are known as MOSFETs. The semiconductor elements of the power electronics preferably form a full bridge to activate the electrical consumer.

### BRIEF DESCRIPTION OF THE DRAWINGS

The invention is described in more detail below with reference to the drawing, in which

FIG. 1 shows a simplified diagram of a household appliance,

FIG. 2 shows the sequence of a method for operating the household appliance and

FIG. 3 shows a diagram to illustrate the method.

### DETAILED DESCRIPTION OF EXEMPLARY EMBODIMENTS OF THE PRESENT INVENTION

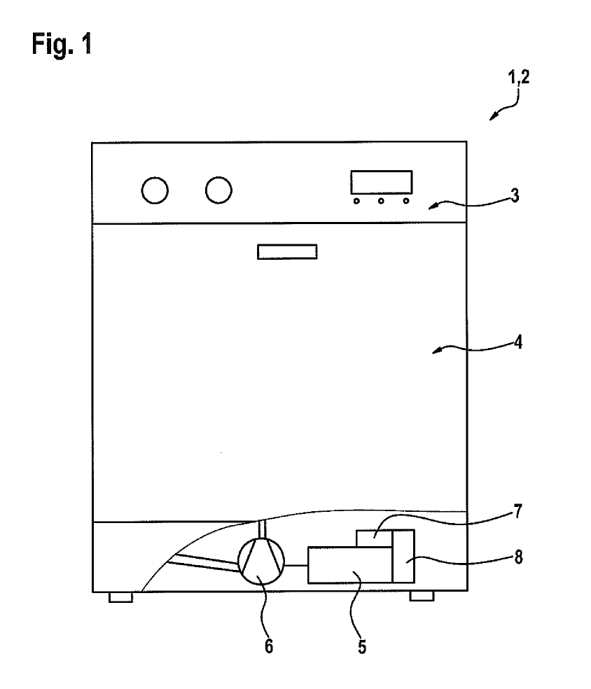

FIG. 1 shows a simplified diagram of an exemplary embodiment of a household appliance 1 in the form of a dishwasher 2 viewed from the front. As well as its control panel 3 with control elements for selecting a desired wash program and a door 4 for closing off a work space of the dishwasher 2, said dishwasher 2 in the present exemplary embodiment comprises an electrical consumer in the form of an electric motor 5, the output shaft of which is actively connected to a pump 6, which can be configured for example as a circulating pump. Assigned to the electric motor 5 are power electronics 7 which are used to activate the electric motor 5. The power electronics 7 comprise several semiconductor elements, which in the present exemplary embodiment are embodied as MOSFETs (metal oxide semiconductor field effect transistors), connected to form a full bridge. The dishwasher 2 also features a facility 8, which enables an overload operation at least temporarily as a function of the current temperature overload of the electric motor 5 or power electronics 7. The overload operation is characterised in that a higher power is required by the electric motor 5 and therefore also by the power electronics 7 than in a normal load operation, with the normal load operation being characterised by a maximum power that can be required permanently by the power electronics 7 and the electric motor 6 without causing component parts of the power electronics 7 or the electric motor 5 to be damaged or to overheat.

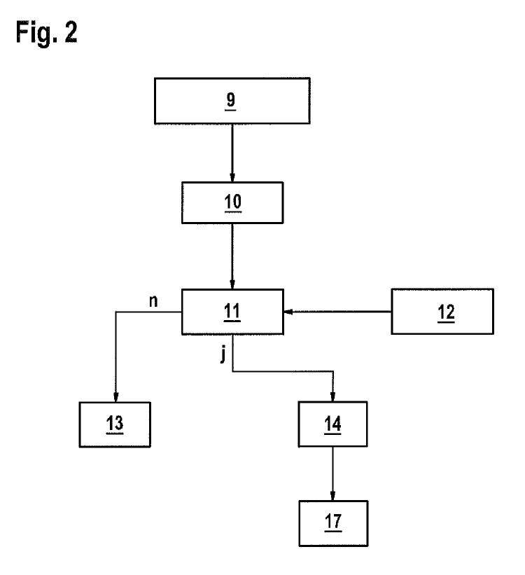

FIG. 2 shows the sequence of a method for operating the dishwasher 2. In a first step 9 operation of the dishwasher 2 is started by selecting a corresponding wash program. In the next step 10 the facility 8 is used to define or determine an actual value representing the temperature loading of the power electronics 7. To this end the facility 8 expediently features a circuit and/or sensor to detect the actual motor current, in particular at least one actual phase current, of the electric motor 5. The actual value is determined by forming a limit load integral as a function of the actual motor current. To this end the actual motor current or the actual value is squared and integrated, to determine how long the power electronics 7 can be subjected to the actual motor current present during overload operation, before a limit value is reached. In other words it is determined how long the power electronics 7 takes until its temperature exceeds the maximal possible temperature. When forming the limit load integral, account is taken of the known thermal time constants of the power electronics 7, in particular of the power semiconductors.

In a next step 11 the actual value is compared with the predeterminable limit value that represents the maximum tolerable temperature loading of the power electronics 7. The limit value has been determined beforehand by tests or calculation in a step 12. The limit value is additionally predetermined as a function of an intermediate circuit voltage of the power electronics 7, in order also to take account of the known switching losses as a function of intermediate circuit voltage during overload protection.

During the comparison in step 11 it is checked whether the actual value is below the limit value. If not (n), in a next step 13 the household appliance 1 continues to be operated in normal load operation, so that the maximum occurring temperature loading of the power electronics does not result in damage or overheating of the power electronics 7 during long-term operation.

However if the comparison in step 11 indicates that the actual value is below the limit value (j), in a next step 14 an enable time is determined for an overload operation, in which the maximum power of normal load operation is exceeded.

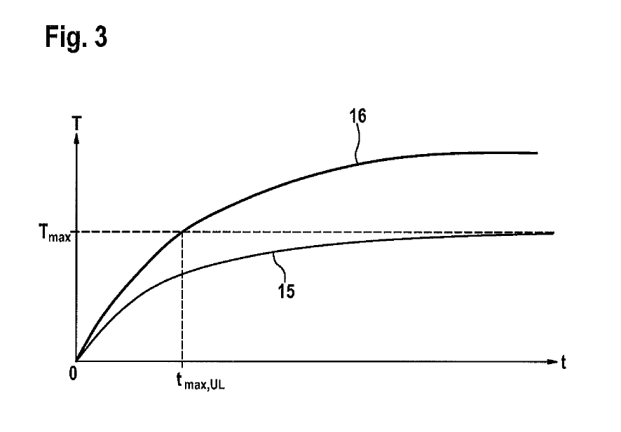

FIG. 3 is a diagram showing the temperature T of the power electronics 7, plotted over time t. Also shown in the diagram is the maximum temperature Tₘₐₓ that can be tolerated by the power electronics 7 and is represented by the limit value. A first curve 15 shows the profile of the temperature of the power electronics 7 in normal load operation, slowly and asymptotically approaching the maximum temperature Tₘₐₓ. During long-term operation of the dishwasher 2 in normal load operation according to curve 15 the maximum temperature Tₘₐₓ is therefore not exceeded and the temperature loading of the power electronics 7 can therefore be tolerated in the long term without damage or overheating occurring.

A second curve 16 shows the profile of the temperature T of the power electronics 7 in an overload operation, in which the power of the electric motor 5 is above the power in normal load operation, so that an increased actual motor current is also present, resulting in faster heating and a greater temperature loading of the power electronics 7. As shown clearly by the diagram in FIG. 3, the temperature of the power electronics 7 reaches the maximum tolerable temperature Tₘₐₓ of the power electronics 7 earlier in overload operation than in normal load operation, at a time t_{max,UL}. If the overload operation takes place beyond time t_{max,UL}, the temperature T of the power electronics 7 exceeds the maximum tolerable temperature Tₘₐₓ.

By defining the limit load integral the maximum time period t_{max,UL} for which overload operation can take place without the power electronics 7 overheating is determined as a function of the actual motor current (i_{I}) present. Once the time period t_{max,UL} is defined, in a final step 17 the overload operation is enabled for the enable time (t_{max,UL}) thus defined.

In a further embodiment during overload operation the actual value is also detected and compared with the limit value and as soon as the actual value reaches the limit value, overload operation is terminated or enabling is retracted. The limit load integral and the actual value are preferably used to define an actual temperature, which is compared with the maximum temperature Tₘₐₓ. This serves as an alternative or additional safety mechanism to prevent the power electronics 7 overheating.

Once the enable time has been reached or the actual value reaches the limit value, the actual motor current is limited to prevent any further increase in the temperature loading. To prevent damage to the semiconductor elements in overload operation, the actual motor current is expediently limited in overload operation as a function of component-specific parameters.

The advantage of the method described above is that an overload operation can be enabled and to enable the overload operation no additional components are required, such as temperature sensors, thereby simplifying production and reducing costs. Also the described method permits overloading of the power electronics, as can occur due to the manufacturing tolerances of the household appliance 1, equally to be prevented.

1. A method for operating a household appliance having at least one electrical consumer activated by power electronics, said method comprising the steps of:
determining an actual value representing a temperature loading of the power electronics;
comparing the actual value with a limit value representing a maximum tolerable temperature loading of the power electronics in normal load operation; and
at least temporarily enabling an overload operation with a higher power than in normal load operation, when the actual value is below the limit value.

2. The method of claim 1 for operating a dishwasher.

3. The method of claim 1, wherein the electrical consumer is an electric motor for driving a pump or a compressor of the household appliance.

4. The method of claim 3, wherein the electric motor is a permanently excited synchronous motor.

5. The method of claim 1, wherein the actual value is determined as a function of an actual consumer current of the electrical consumer.

6. The method of claim 1, wherein the actual value is determined as a function of at least one actual phase current of the electrical consumer.

7. The method of claim 1, wherein the actual value is determined by forming a limit load integral.

8. The method of claim 1, wherein the actual value is determined by integrating a squared actual consumer current.

9. The method of claim 1, wherein the actual value is determined by integrating a squared actual phase current.

10. The method of claim 1, wherein the overload operation is enabled until the actual value reaches the limit value.

11. The method of claim 8, wherein the actual consumer current is limited when the actual value reaches the limit value.

12. The method of claim 9, wherein the actual phase current is limited when the actual value reaches the limit value.

13. The method of claim 1, wherein the limit value is predetermined as a function of an intermediate circuit voltage of the power electronics.

14. The method of claim 8, wherein an integration time is defined as a function of at least one known thermal time constant of the power electronics.

15. The method of claim 1, wherein the actual consumer current in overload operation is limited as a function of a component-specific parameter.

16. A household appliance, comprising:
at least one electrical consumer;
a power electronics operably connected to the electrical consumer; and
a facility for determining an actual value representing a temperature of the power electronics and for comparing a limit value representing a maximum tolerable temperature loading of the power electronics in normal load operation; said facility enabling an overload operation, when the actual value is below the limit value.

17. The household appliance of claim 16 constructed in the form of a dishwasher.
